(19) United States
(12) Patent Application Publication
(10) Pub. No.: US 2011/0202855 A1
(43) Pub. Date: Aug. 18, 2011

(54) GUI EVALUATION SYSTEM, GUI EVALUATION METHOD, AND GUI EVALUATION PROGRAM

(76) Inventor: Teruya Ikegami, Tokyo (JP)

(21) Appl. No.: 13/063,124

(22) PCT Filed: Aug. 7, 2009
(86) PCT No.: PCT/JP2009/003827

§ 371 Date: Mar. 9, 2011

(30) Foreign Application Priority Data
Sep. 29, 2008 (JP) 2008-251809

(51) Int. Cl. G06F 3/01

(52) U.S. Cl. 715/762

(57) ABSTRACT

The consistency of the layout of operating buttons in evaluated screens is exhaustively and reliably evaluated. A GUI evaluation system comprises an evaluation button information storage means for storing evaluation button information which indicates each category corresponding label information being text used as a label of the operation button that is disposed in an evaluation target screen and used for a basic operation; a GUI information storage means for storing GUI information including a size of the evaluation target screen and each button included in the screen, and GUI information including the label information and coordinate data indicative of a position of each button in the screen; a button group specification means for specifying an operation button group, based on inter-button distance referenced to the operation button, on buttons disposed in the evaluation target screen at each evaluation target screen, in accordance with the GUI information stored in the GUI information storage means and the evaluation button information stored in the evaluation button information storage means; and a button layout evaluation means for evaluating a layout consistency of operation buttons between a plurality of evaluation target screens by comparing operation button groups each including an operation button belonging to a same category as the other operation button group, each of the operation button groups being specified from each of the evaluation target screens.

### TECHNICAL FIELD

The present invention relates to a GUI evaluation system, GUI evaluation method, and GUI evaluation program for evaluating the usability of a system, and more particularly to, a GUI evaluation system, GUI evaluation method, and GUI evaluation program for evaluating the layout consistency of operation buttons.

### BACKGROUND ART

When the layout consistency of operation buttons in a system's GUI (graphical user interface) is to be evaluated, or more specifically, when the layout consistency of on-screen basic operation buttons such as those for decision making by a user or calling a help topic is to be evaluated to check whether or not they are consistently laid out within the system, it is preferred that the layout of operation buttons on each screen be checked to extract any inconsistent portion while buttons offering screen-specific functions and a “Ref.” button for specifying a file path are excluded from evaluation. Therefore, when this evaluation is performed manually, increased workload is imposed on an evaluator. Further, the evaluator may fail, for instance, to detect all inconsistencies. Consequently, the result of evaluation is likely to vary from one evaluator to another.

A first related art is a technology related to a GUI automatic evaluation device that is described in Patent Document 1. The GUI automatic evaluation device inputs screen design guide data, stores the input guide data as formal rules, compares GUI information that includes window-specific attribute information and attribute values representing GUI object data of an evaluation target system, with the stored rules, and outputs the window-specific result of comparison with the GUI information with the rules. Patent Document 1 also describes means for generating GUI information, for instance, from product specifications, sources, and GUI building tools.

A second related art is a technology related to a testing device that is described in Patent Document 2. The testing device is capable of conducting a test in which a predetermined operating procedure is automatically performed. The testing device uses an operation database to store a user sequence which is to be designated by a user at the time of testing, and a complementary sequence which ensures that the user sequence is executed in a specified manner, and verifies the status of a GUI portion when the user sequence is executed in the specified manner. The testing device executes the user sequence whenever it can be executed. However, when the user sequence cannot be executed, the testing device retrieves an appropriate complementary sequence, executes the retrieved complementary sequence, and then executes the user sequence.

A third related art is a technology related to a web screen creation tool and terminology check tool described in Patent Document 3. These tools check a web screen source file by using terminology pre-registered for verifying homonyms, declensional Kana endings, and synonyms which are prone to error when they are written. If any pre-registered term is detected within a web screen to be evaluated, these tools display a list of possible corrections for the detected term.

### CITATION LIST

### Patent Literature

Patent Document 1 Japanese Patent Application Publication No. 1996-241191
Patent Document 2 Japanese Patent Application Publication No. 2004-110267
Patent Document 3 Japanese Patent Application Publication No. 2004-234402

### SUMMARY OF INVENTION

### Technical Problem

One problem is that when the layout consistency of operation buttons on each screen is evaluated, some portions are likely to be left unchecked due to an increased workload on an evaluator. Another problem is that when the layout consistency of individual buttons is evaluated mechanically from property values of the buttons, a non-problematic case may be erroneously extracted.

One reason is that it is difficult for the evaluator to specify the buttons to be subjected to consistency evaluation because the screens to be evaluated differ in functionality. Another reason is that the evaluator has to check and record the button layout for each screen to be evaluated. Further, when the combination of operation buttons to be laid out varies, the layout of individual buttons varies from one screen to another. However, relative layout in different screens may remain consistent when on-screen buttons are viewed as an aggregate of buttons. Eventually, it is difficult to properly evaluate the layout of such an aggregate of buttons.

The GUI automatic evaluation device described in Patent Document 1 needs to input screen design guide data and create rules. However, it is difficult to input the guide data for properly creating the rules for evaluating the layout consistency of operation buttons. For example, it is possible to acquire the property values of operation buttons in each screen and mechanically make a layout comparison between operation buttons having the same label. However, the operation buttons having the same label may vary their on-screen position or other operation buttons may be added. It is therefore necessary to determine whether or not the relative layout of an aggregate of on-screen buttons, including the positional relationship to the other operation buttons, should be checked for consistency.

The testing device described in Patent Document 2 is capable of checking whether or not a predetermined user sequence is properly executed. For the testing device, however, it is necessary to prepare sequences in accordance with the system to be evaluated. In addition, the testing device cannot evaluate a GUI portion within a sequence execution or evaluate the sequences themselves.

The web screen creation tool and terminology check tool described in Patent Document 3 cannot evaluate the usability characteristics of terms other than unregistered ones.

The present invention has been made in view of the above circumstances. An object of the present invention is to provide a GUI evaluation system, GUI evaluation method, and GUI evaluation program that are capable of comprehensively and unfailingly evaluating the layout consistency of operation buttons in a screen targeted for evaluation.

### Solution to Problem

A GUI evaluation system, according to the present invention comprising an evaluation button information storage means for storing evaluation button information which indicates each category corresponding label information being text used as a label of the operation button that is disposed in an evaluation target screen and used for a basic operation, each category indicated by a type of operation performed by the operation button; a GUI information storage means for storing GUI information including a size of the evaluation target screen and each button included in the screen, and GUI information including at least the label information and coordinate data indicative of a position of each button in the screen; a button group specification means for specifying an operation button group, based on inter-button distance referenced to the operation button, on buttons disposed in the evaluation target screen at each evaluation target screen, in accordance with the GUI information stored in the GUI information storage means and the evaluation button information stored in the evaluation button information storage means; and a button layout evaluation means for evaluating a layout consistency of operation buttons between a plurality of evaluation target screens by comparing operation button groups each including an operation button belonging to a same category as the other operation button group, each of the operation button groups being specified from each of the evaluation target screens.

A GUI evaluation method, according to the present invention comprising the steps of: specifying an operation button group, based on inter-button distance referenced to an operation button, on buttons disposed in an evaluation target screen at each evaluation target screen, in accordance with evaluation button information and GUI information, the evaluation button information which indicates each category corresponding label information being text used as a label of the operation button that is disposed in an evaluation target screen and used for a basic operation, each category indicated by a type of operation performed by the operation button, and the GUI information including a size of the evaluation target screen and each button included in the screen, and the GUI information further including at least the label information and coordinate data indicative of a position of each button in the screen; and evaluating the layout consistency of operation buttons between a plurality of evaluation target screens by comparing operation button groups each including operation buttons belonging to an identical category that is the same category as the other operation button group, each of the operation button groups being specified from each of the evaluation target screens.

A GUI evaluation program according to the present invention, making a computer perform: a button group specification process for specifying an operation button group, based on inter-button distance referenced to an operation button, on buttons disposed in an evaluation target screen at each evaluation target screen, in accordance with evaluation button information and GUI information, the evaluation button information which indicates each category corresponding label information being text used as a label of the operation button that is disposed in an evaluation target screen and used for a basic operation, each category indicated by a type of operation performed by the operation button, and the GUI information including a size of the evaluation target screen and each button included in the screen, and the GUI information further including at least the label information and coordinate data indicative of a position of each button in the screen; and a button layout evaluation process for evaluating the layout consistency of operation buttons between a plurality of evaluation target screens by comparing operation button groups each including operation buttons belonging to an identical category that is the same category as the other operation button group, each of the operation button groups being specified from each of the evaluation target screens.

### Advantageous Effects of the Invention

The present invention makes it possible to comprehensively and unfailingly evaluate the layout consistency of operation buttons in a screen targeted for evaluation.

### BRIEF DESCRIPTION OF DRAWINGS

FIG. 1 It depicts a block diagram illustrating an example configuration of a GUI evaluation system according to the present invention.

FIG. 2 It depicts a block diagram illustrating an example configuration of the GUI evaluation system according to a first exemplary embodiment of the present invention.

FIG. 3 It depicts an example of evaluation button information stored in an evaluation button information recording section 4.

FIG. 4 It depicts an example of an evaluation target screen.

FIG. 5 It depicts an example of GUI information.

FIG. 6 It depicts another example of GUI information.

FIG. 7 It depicts a flowchart illustrating an example of a heading group specification operation by a heading group specification section 2.

FIG. 8 It depicts a flowchart illustrating an example of an operation button layout consistency evaluation operation by a button layout judgment section 3.

FIG. 9 It depicts an example of the evaluation target screen.

FIG. 10 It depicts an example of operation button group specification in the evaluation target screen.

FIG. 11 It depicts an example of operation button group information.

FIG. 12 It depicts an example of operation button group specification in the evaluation target screen.

FIG. 13 It depicts an example of the operation button group information.

FIG. 14 It depicts an example of the evaluation target screen and an example of operation button group specification in the evaluation target screen.

FIG. 15 It depicts an example of the evaluation target screen and an example of operation button group specification in the evaluation target screen.

FIG. 16 It depicts a block diagram illustrating an example configuration of the GUI evaluation system according to a second exemplary embodiment of the present invention.

FIG. 17 It depicts an example of the evaluation target screen and an example of operation button group specification in the evaluation target screen.

FIG. 18 It depicts an example of the evaluation target screen and an example of operation button group specification in the evaluation target screen.

FIG. 19 It depicts an example of the evaluation target screen and an example of operation button group specification in the evaluation target screen.

FIG. 20 It depicts a block diagram illustrating an example configuration of the GUI evaluation system according to a third exemplary embodiment of the present invention.

FIG. 21 It depicts an example of the evaluation target screen and an example of operation button group specification in the evaluation target screen.

FIG. 22 It depicts an example of operation button group specification by a button group extension section 21.

FIG. 23 It depicts a block diagram illustrating another example configuration of the GUI evaluation system according to the third exemplary embodiment of the present invention.

FIG. 24 It depicts an example of the evaluation target screen and an example of operation button group specification in the evaluation target screen.

FIG. 25 It depicts a block diagram illustrating an example configuration of the GUI evaluation system according to a fourth exemplary embodiment of the present invention.

FIG. 26 It depicts an example of the evaluation target screen and an example of operation button group specification in the evaluation target screen.

FIG. 27 It depicts an example of the evaluation target screen and an example of operation button group specification in the evaluation target screen.

FIG. 28 It depicts an example of the evaluation target screen and an example of operation button group specification in the evaluation target screen.

### DESCRIPTION OF EMBODIMENTS

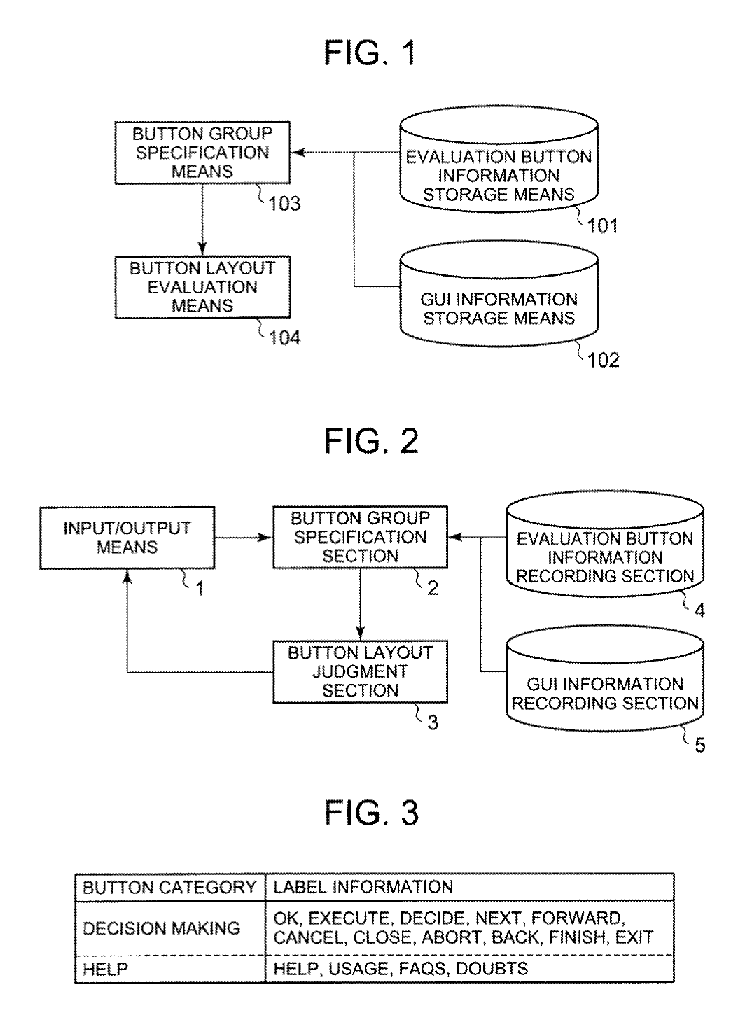

Embodiments of the present invention will be described with reference to the accompanying drawings. FIG. 1 is a block diagram illustrating an example configuration of a GUI evaluation system according to the present invention. The GUI evaluation system shown in FIG. 1 includes evaluation button information storage means 101, GUI information storage means 102, button group specification means 103, and button layout evaluation means 104.

The evaluation button information storage means 101 stores evaluation button information, which is obtained by classifying label information according to the category indicated by the type of operation performed by using an operation button used for a basic operation. The label information indicates text used as a label on the operation button.

The GUI information storage means 102 stores GUI information concerning the size of an evaluation target screen and each button included in the screen. The GUI information includes at least the label information and coordinate data indicative of the position of each button in the screen.

The button group specification means 103 specifies an operation button group based on inter-button distance referenced to an operation button, on buttons disposed in the evaluation target screen at each evaluation target screen, in accordance with the GUI information stored in the GUI information storage means 102 and the evaluation button information stored in the evaluation button information storage means 101.

The button layout evaluation means 104 evaluates the layout consistency of operation buttons between a plurality of evaluation target screens by comparing operation button groups including operation buttons belonging to the same category, which are specified from the evaluation target screens.

The button group specification means 102 may extract operation buttons disposed in an evaluation target screen in accordance with the evaluation button information stored in the evaluation button information storage means 101, by using one of the extracted operation buttons as an initial base point, repeatedly search for a neighboring operation button within a predetermined rectangular range from the operation button used as the initial base point until no more operation button is found with the newly found operation button used as the next base point, and specify the operation button used as the initial base point and the later-found operation buttons as the members of the same operation button group.

The button layout evaluation means 103 may compare comparison elements of operation buttons in operation button groups including operation buttons belonging to the same category, the comparison elements being the direction of operation button arrangement and the relative position in a screen. When the operation buttons do not agree with each other in any one of the comparison elements in any combination, the button layout evaluation means 103 may conclude that the operation buttons are inconsistent in layout.

The button layout evaluation means 103 may compare the order of arrangement of operation buttons having the same label between operation button groups including operation buttons belonging to the same category. When any combination exhibits a conflicting order of arrangement, the button layout evaluation means 103 may conclude that the operation buttons are inconsistent in the order of arrangement.

When a certain operation button group specified from an evaluation target screen does not include all operation buttons that belong to the category to which the operation buttons specified as the members of the operation button group belong and are used in the evaluation target screen, the button group specification means 102 may search a search range within the evaluation target screen in the direction of button arrangement of the operation button group, in order to find the excluded operation buttons. When any such excluded operation button is found within the search range, the button group specification means 102 may newly specify the found operation button as a member of the operation button group.

In the above instance, the button layout evaluation means 103 may compare the interval of arrangement between operation button groups including operation buttons belonging to the same category, the interval of arrangement being the distance between operation buttons having the same label and the other operation buttons. When any combination exhibits a conflicting interval of arrangement, the button layout evaluation means 103 may conclude that the operation buttons are inconsistent in the interval of arrangement.

### First Embodiment

Embodiments of the present invention will now be described in greater detail. FIG. 2 is a block diagram illustrating an example configuration of the GUI evaluation system according to a first exemplary embodiment of the present invention. The GUI evaluation system shown in FIG. 2 includes input/output means 1, a button group specification section 2, a button layout judgment section 3, an evaluation button information recording section 4, and a GUI information recording section 5.

The input/output means 1 includes input means and output means. The input means is a mouse, keyboard, or other device for entering information that specifies the operation to be performed by an evaluator. The output means is a display or other output device.

The evaluation button information recording section 4 stores evaluation button information, which is the information for specifying an operation button by which the system examines for layout consistency evaluation. The first exemplary embodiment stores the evaluation button information, which is obtained by classifying label information according to the category indicated by the type of operation performed by an operation button. The label information is the information, for instance, about text that is often used as a label on the operation button.

FIG. 3 shows an example of evaluation button information stored in the evaluation button information recording section 4. As shown in FIG. 3, the evaluation button information may include, for instance, the label information and information indicative of an operation button category. In the example shown in FIG. 3, the evaluation button information is stored while the label information frequently used for an operation button is categorized according to the type of operation performed by the operation button. For example, FIG. 3 shows that eleven pieces of label information such as “OK” and “Execute” are registered as the information indicative of operation buttons belonging to a “Decision Making” category, which is a category of operation buttons frequently used for decision making. FIG. 3 also shows that four pieces of label information such as “Help” and “Usage” are registered as the information indicative of operation buttons belonging to a “Help” category.

The GUI information recording section 5 stores GUI information concerning the window size (screen size) of an evaluation target screen and each button included in the screen. The GUI information includes at least the label information and coordinate data indicative of the position of each button in the screen.

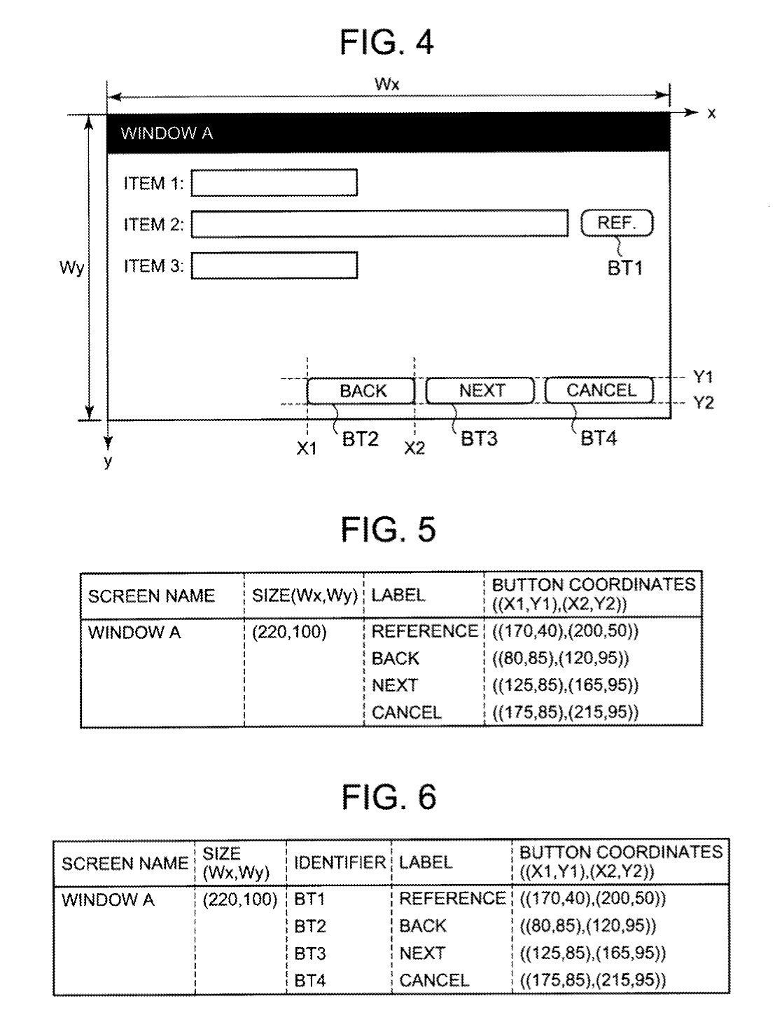

FIG. 4 shows an example of an evaluation target screen. The GUI information about the evaluation target screen (window A) shown in FIG. 4 is acquired, for instance, in a manner described below. First of all, a window size (Wx,Wy) is acquired with coordinate axes defined with respect to the upper left corner of the evaluation target screen (window A). Further, the upper left coordinates (X1,Y1) and lower right coordinates (X2,Y2) of each button in the evaluation target screen (window A) are acquired as button coordinates. FIG. 5 shows an example of GUI information about the evaluation target screen (window A) shown in FIG. 4. The example shown in FIG. 5 indicates that window A includes four buttons while its window size (Wx,Wy)=(220,100). The example also indicates that one of the four buttons is labeled “Ref.” while its coordinates ((X1,Y1),(X2,Y2))=((170,40),(200,50)). As shown in FIG. 6, the GUI information may include a button identifier for identifying a button (button identifier).

In the present exemplary embodiment, a method for generating the GUI information is not specifically defined. The evaluator may make manual entries to generate the GUI information. Alternatively, the GUI information may be generated by acquiring screen information from applicable specifications and an actual system and subjecting the acquired screen information to syntax analysis, layout analysis, or other analysis based on an'existing technology. In the present exemplary embodiment, the layout of operation buttons is evaluated in accordance with the GUI information stored in the GUI information recording section 5.

The button group specification section 2 references the GUI information stored in the GUI information recording section 5 and the evaluation button information stored in the evaluation button information recording section 4, and specifies an operation button group which is formed by buttons disposed in the evaluation target screen and based on inter-button distance referenced to an operation button. The button group specification section 2 searches the buttons included in the evaluation target screen for an operation button that is to be evaluated. When any such operation button is found, the button group specification section 2 specifies the operation button and a button existing within a predetermined rectangular range from the operation button as the buttons belonging to the same operation button group. The button group specification section 2 continues to specify a button existing within a predetermined rectangular range from the newly specified operation button as another button belonging to the same operation button group. In a manner described above, all the buttons subsequently specified as the buttons belonging to the same operation button group are then used to search for a new button. One operation button group is specified by repeating the above-described search process until no more new button is found. Further, the button group specification section 2 generates information indicative of the operation button group specified as described above, and outputs the generated information to the button layout judgment section 3 as the operation button group information.
The button layout judgment section 3 compares operation button groups in various screens in accordance with the operation button group information generated by the button group specification section 2, and checks whether or not the layout of operation buttons is consistent between the evaluation target screens. For example, the button layout judgment section 3 may check the operation button groups in the screens for the direction of button arrangement and the relative position in a screen, compare the direction of button arrangement and the relative position in a screen between the operation button groups including operation buttons that belong to the same category and different screens, and check for any mismatch for evaluation purposes.

In the present exemplary, the button group specification section 2 and the button layout judgment section 3 are implemented, for instance, by a CPU that operates in accordance with a program. The evaluation button information recording section 4 and the GUI information recording section 5 are implemented by a storage device.

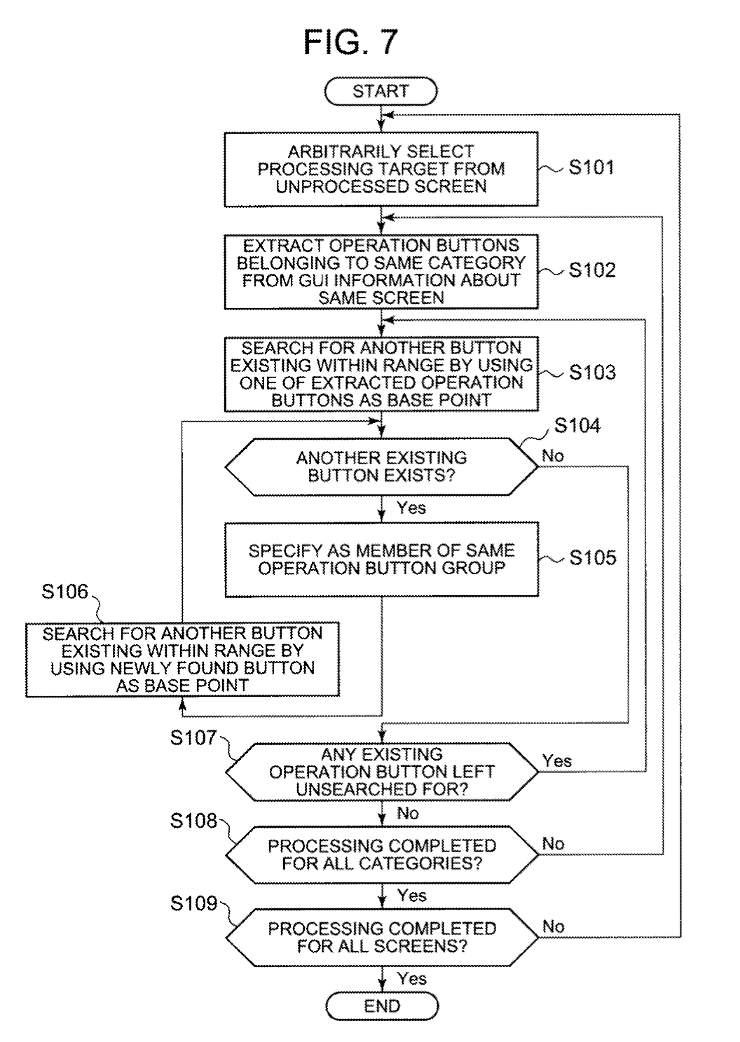

An operation of the present exemplary embodiment will now be described. FIG. 7 is a flowchart illustrating an example of a heading group specification operation by a heading group specification section 2. In the example shown in FIG. 7, the button group specification section 2 first arbitrarily selects a processing target from an unprocessed screen (step S101). Then, the button group specification section 2 extracts operation buttons belonging to the same category from the GUI information about the screen (step S102).

Next, the button group specification section 2 searches for another button existing within a predetermined range by using one of the extracted operation buttons as a base point (step S103). When another button is found, the button group specification section 2 specifies it as a member of the same operation button group as for the operation button used as the base point in step S103 (answers “YES” to the query in step S104: step S105). The button group specification section 2 continues to repeat a process for searching for another button existing within a predetermined range by using the newly found button as a new base point (performs step S106 and then returns to step S104). The button group specification section 2 may repeat the search process by using the operation button as the new base point only when, for instance, the newly found button is an operation button belonging to the same category. In such an instance, the button group specification section 2 may judge whether or not a button found in a search conducted by using a certain operation button as a base point has already been found in a previous search conducted by using another operation button as a base point. If the button found in a search conducted by using a certain operation button as a base point has already been found in a previous search conducted by using another operation button as a base point, the button group specification section 2 may specify a button specified as a member of the same operation button group in the search process based on the operation button as a button belonging to the same operation button group as a button specified as a member of the same operation button group in the search process based on the other operation button.

When no more new button is found in a search process performed by using an operation button as the initial base point (when the query in step S104 is answered “NO”), the button group specification section 2 completes the search process concerning the operation button group.

If any of the operation buttons extracted in step S102 is still not searched for, the button group specification section 2 performs the same search process by using such an operation button as an initial base point for a different operation button group (answers “YES” to the query in step S107 and then returns to step S103). If, on the other hand, all the operation buttons extracted in step S102 are searched for (if the query in step S107 is answered “NO”), the button group specification section 2 extracts operation buttons and repeats the same process for any unprocessed category (answers “NO” to the query in step S108 and then returns to step 102). An alternative is to assume that the number of operation button groups belonging to the same category is limited to one for each screen, and skip the judgment process in step S107.

When the operation button group specification process is completed for all categories, the button group specification section 2 repeats the same process for any unprocessed screen (answers “NO” to the query in step S109 and then returns to step S101).

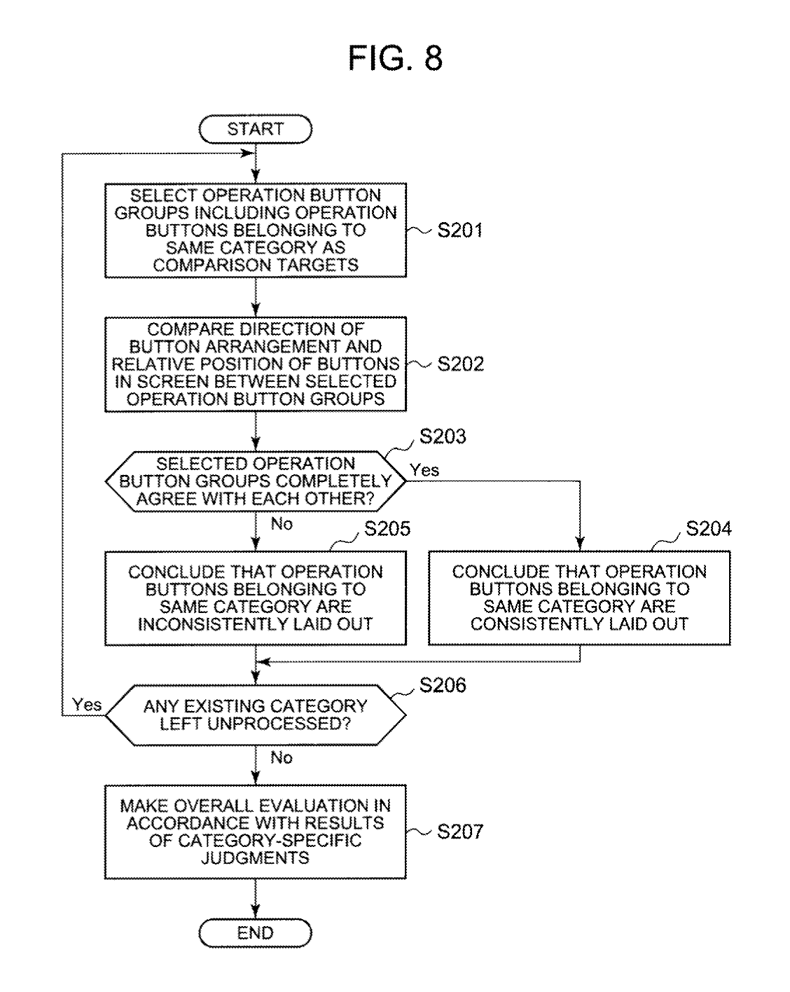

FIG. 8 is a flowchart illustrating an example of an operation button layout consistency evaluation operation by the button layout judgment section 3. In the example shown in FIG. 8, the button layout judgment section 3 first selects operation button groups including operation buttons belonging to the same category from operation button groups included in an evaluation target screen as comparison targets (step S201).

The button layout judgment section 3 then performs step S202 to compare the direction of button arrangement and the relative position of buttons in a screen between the selected operation button groups.

When the selected operation button groups completely agree with each other in the direction of button arrangement and the relative position of buttons in a screen (when the query in step S203 is answered “YES”), the button layout judgment section 3 concludes that the operation buttons belonging to the same category are consistently laid out (step S204). When, on the other hand, any operation button group differs from the others in either the direction of button arrangement or the relative position of buttons in a screen (when the query in step S203 is answered “NO”), the button layout judgment section 3 concludes that the operation buttons belonging to the same category are inconsistently laid out (step S205).

If the above-described operation button layout consistency judgment process is not completed for all categories (if the query in step S206 is answered “YES”), the button layout judgment section 3 selects an unprocessed category as a processing target and performs the same process as described above (returns to step S201). If, on the other hand, the operation button layout consistency judgment process is completed for all categories (if the query in step S206 is answered “NO”), the button layout judgment section 3 makes an overall evaluation in accordance with the results of category-specific judgments (step S207).

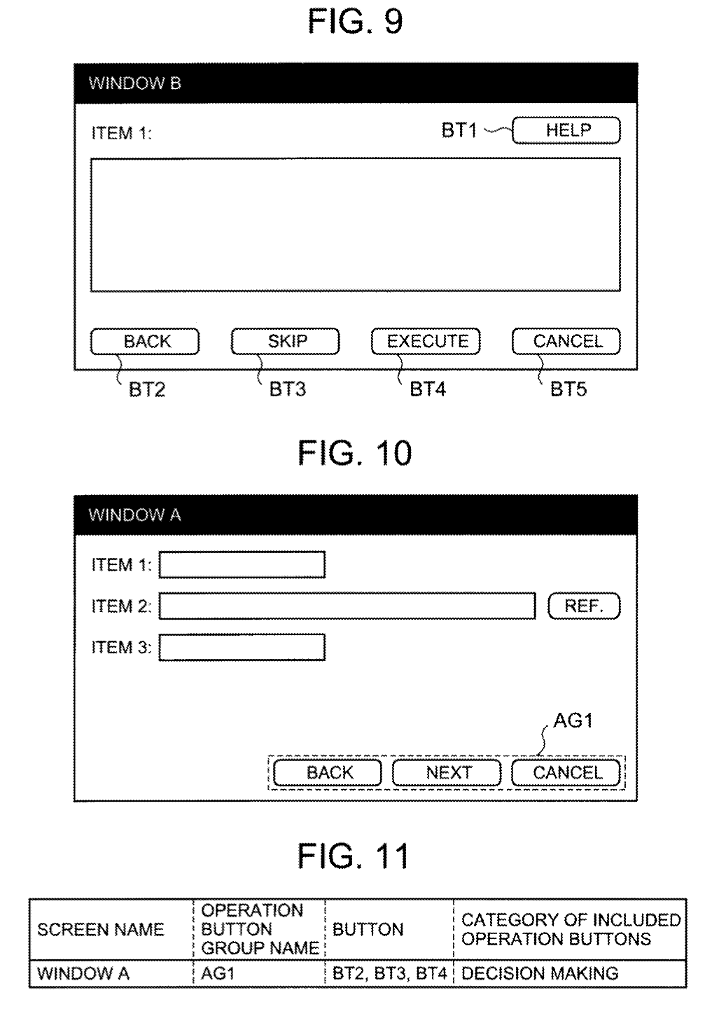

An operation of the present exemplary embodiment will now be described with reference to concrete screen examples. In a first example, window A shown in FIG. 4 and window B shown in FIG. 9 are used as the evaluation target screens.

First of all, the button group specification section 2 extracts operation buttons belonging to the “Decision Making” category from buttons included in window A shown in FIG. 4 in accordance with the GUI information stored in the GUI information recording section 5. In the present example, the button group specification section 2 extracts a “Back” button (BT2), a “Next” button (BT3), and a “Cancel” button (BT4).

Next, the button group specification section 2 searches for another button included within a predetermined range by using one of the extracted buttons as an initial base point. In the present example, a neighboring button is searched for by checking a predetermined search range that is 5 in height and 10 in width. The button group specification section 2 first checks for another button within the predetermined rectangular range by using the “Back” button (BT2) as a base point. In the present example, the button group specification section 2 finds the “Next” button (BT3) which is located on the right-hand side of the predetermined range, and specifies the “Next” button (BT3) as a member of the same operation button group (AG1). The button group specification section 2 then searches for another button belonging to the same operation button group by using the “Next” button (BT3) as a base point. In the present example, the button group specification section 2 finds the “Cancel” button (BT4) during the search process performed by using the “Next” button (BT3) as a base point, and specifies the “Cancel” button (BT4) as another member of the same operation button group (AG1). The button group specification section 2 then performs the same search process by using the “Cancel” button (BT4) as a base point. However, as no other button exists within the predetermined range, the button group specification section 2 concludes the search process.

As all the operation buttons extracted as the members of the “Decision Making” category have been searched for and found, the operation button group specification process for the “Decision Making” category is considered complete. As regards an operation button group including operation buttons belonging to the “Decision Making” category (hereinafter referred to as an operation button group involving the “Decision Making” category), one operation button group (AG1) including the “Back” button (BT2), “Next” button (BT3), and “Cancel” button (BT4) is specified (see FIG. 10). FIG. 10 shows an example of the result of operation button group specification concerning window A.

Next, the button group specification section 2 extracts an operation button belonging to the “Help” category from buttons included in window A shown in FIG. 4. In the present example, however, window A does not include an operation button belonging to the “Help” category. Therefore, as regards an operation button group including operation buttons belonging to the “Help” category (hereinafter referred to as the operation button group involving the “Help” category), no operation button group is specified (the number of specified operation button groups is zero). The “Ref.” button (BT1) in window A is not registered as an operation button having a button label defined by the evaluation button information. Therefore, the “Ref.” button (BT1) will not be extracted as an operation button, and no search process will be performed by using the “Ref.” button (BT1) as a base point. Further, the “Ref.” button (BT1) is specified as a button that does not belong to any operation button group because it is not positioned within a predetermined range from all the extracted operation buttons.

Next, the button group specification section 2 concludes that window A includes one operation button group AG1, generates operation button group information as indicated in FIG. 11, and outputs the operation button group information to the button layout judgment section 3. The example shown in FIG. 11 is a set of correlated pieces of operation button group information including the information about an identifier for identifying a screen (a screen name in the example), an identifier for identifying an operation button group specified from the screen (a group identifier in the example), an identifier for identifying an operation button belonging to the operation button group (a button identifier in the example), and a category to which the operation button group belongs (a category to which operation buttons included in the operation button group belong).

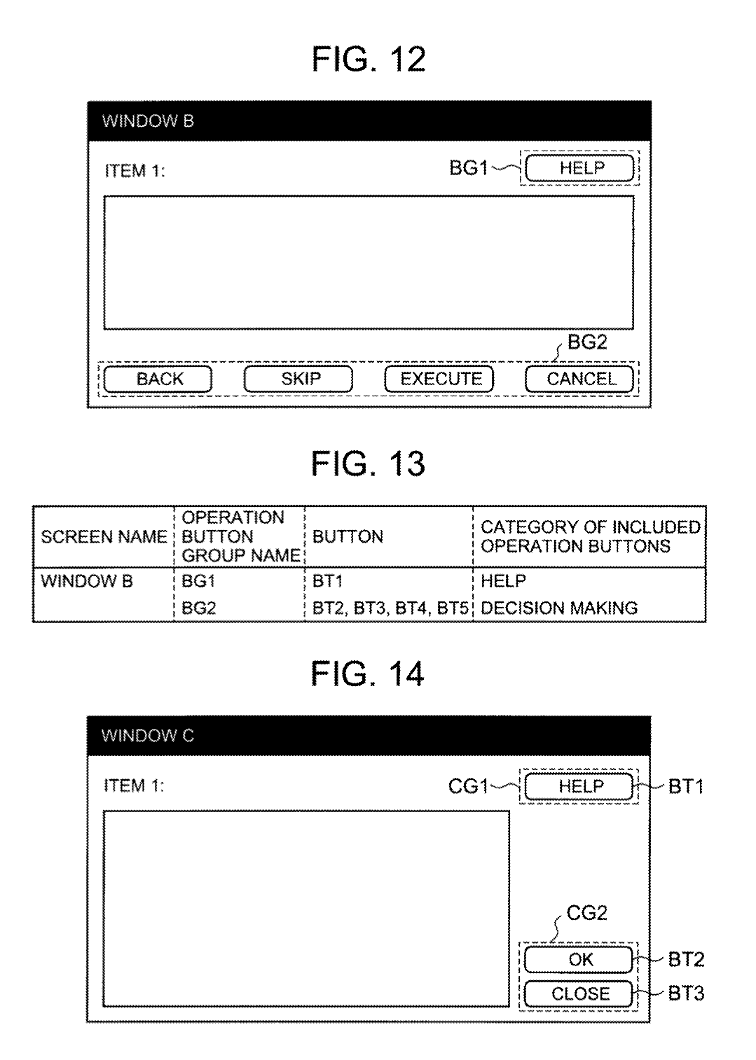

Further, the button group specification section 2 performs the same process for window B as for window A, specifies an operation button group from buttons used in window B, and generates operation button group information. In the present example, as for window B, one operation button group (BG1) including a “Help” button (BT1) is specified as an operation button group involving the “Help” category, and another operation button group (BG2) including the “Back” button (BT2), “Skip” button (BT3), “Execute” button (BT4), and “Cancel” button (BT5) is specified as an operation button group involving the “Decision Making” category, as shown in FIG. 12. The operation button group information shown in FIG. 13 is then generated. FIG. 12 shows an example of the result of operation button group specification concerning window B. FIG. 13 shows an example of operation button group information about window B.

Next, the button layout judgment section 3 references the operation button group information which is output from the button group specification section 2, and the GUI information, and compares the direction of button arrangement and the relative position of buttons in a screen between operation button groups that are specified from the evaluation target screen and involve the same category.

First of all, the button layout judgment section 3 checks the operation button groups specified from window A for the direction of button arrangement and the relative position of buttons in a screen. The direction of button arrangement can be specified from coordinate data about individual buttons, which indicates a direction in which the buttons included in the operation button groups are arranged. In the present example, the direction of button arrangement is checked to determine whether the buttons are arranged in a “vertical direction,” in a “horizontal direction,” in a “vertical or horizontal direction,” or in “some other direction.” The buttons in the operation button group AG1 are specified as being arranged in the “horizontal direction.” When the buttons are said to be arranged in the “vertical direction,” it means that the number of buttons arranged in the vertical direction is larger than the number of buttons arranged in the horizontal direction. When the buttons are said to be arranged in the “horizontal direction,” it means that the number of buttons arranged in the horizontal direction is larger than the number of buttons arranged in the vertical direction. When the buttons are said to be arranged in the “vertical or horizontal direction,” it means that the number of buttons arranged in the vertical direction is equal to the number of buttons arranged in the horizontal direction. When the buttons are said to be arranged in “some other direction,” it means that the buttons included an operation button group are arranged neither in the vertical direction nor in the horizontal direction.

The relative position in a screen is specified by checking whether or not the upper, lower, right, and left sides of an outline enclosing the whole button group are positioned within a predetermined distance from the corresponding sides of a window outline. In the present example, it is assumed that the predetermined distance is 10 in both the horizontal and vertical directions. As regards the operation button group AG1, for example, the relative position is specified as being “lower right” because the right and lower sides of the group outline are adjacent to the right and lower sides of the window outline, respectively.

Similarly, as regards the operation button group BG1 which is specified from window B, the direction of button arrangement is specified as the “vertical or horizontal direction,” and the relative position in a screen is specified as being “upper right” because the right and upper sides of the group outline are adjacent to the right and upper sides of the window outline, respectively. Further, as regards the operation button group BG2, the direction of button arrangement is specified as the “horizontal direction,” and the relative position in a screen is specified as being “lower left,” “lower central,” or “lower right” because the left, right, and lower sides of the group outline are adjacent to the left, right, and lower sides of the window outline, respectively. It should be noted that the relative position in a screen may be specified as being “lower left” or “lower right” depending on whichever side, right side or left side, of the window outline is more adjacent to the operation button group than another side of the window outline.

Next, the button layout judgment section 3 checks for layout inconsistency by comparing the direction of button arrangement and the relative position of buttons in a screen between operation button groups involving the same category and judging whether or not the operation button groups entirely agree with each other. In the present example, the operation button group AG1 specified from window A and the operation button group BG2 specified from window B are compared as the operation button groups involving the “Decision Making” category. In this instance, the operation button group AG1 and the operation button group BG2 agree with each other in the direction of button arrangement as their buttons are both arranged in the “horizontal direction.” Further, these two button groups also agree with each other in the relative position of buttons in a screen as their relative button positions are both “lower right.” Therefore, the button layout judgment section 3 concludes that the operation buttons belonging to the “Decision Making” category are consistently laid out. Although window B includes the operation button group BG1 which involves the “Help” category, there is no other operation button group that involves the “Help” category. Therefore, the button layout judgment section 3 concludes, without making a comparison, that operation buttons belonging to the “Help” category are consistently laid out. It means that the layout of operation buttons belonging to all categories is consistent between all the evaluation target screens. Eventually, the GUI evaluation system also'concludes that the operation buttons are consistently laid out.

As described above, button groups are specified in accordance with buttons defined by category. Further, button groups including buttons belonging to the same category are compared for consistency evaluation purposes. Therefore, the relative layout of on-screen buttons can be evaluated to check for layout inconsistency even when the type and the number of buttons vary from one screen to another.

A second concrete example of an operation of the present exemplary embodiment will now be described with reference to a case where the evaluation target screens include window C, which is shown in FIG. 14.

The button group specification section 2 performs the same process for window C as for windows A and B, specifies an operation button group from buttons used in window C, and generates operation button group information. In the present example, as for window C, one operation button group (CG1) including the “Help” button (BT1) is specified as an operation button group involving the “Help” category, and another operation button group (CG2) including an “OK” button (BT1) and “Close” button (BT3) is specified as an operation button group involving the “Decision Making” category, as shown in FIG. 14. Operation button group information indicative of the result of such specification is then generated.

Next, the button layout judgment section 3 references the operation button group information, which is output from the button group specification section 2, and the GUI information, and compares the direction of button arrangement and the relative position of buttons in a screen between operation button groups that are specified from the evaluation target screen and involve the same category.

As regards the operation button groups CG1 and CG2 included in window C, the button layout judgment section 3 specifies the direction of button arrangement and the relative position of buttons in a screen as described below. As regards the operation button group CG1, the direction of button arrangement is specified as being the “vertical or horizontal direction,” and the relative position of buttons in a screen is specified as being “upper right” because the operation button group is adjacent to the right and upper sides of the window outline. As regards the operation button group CG2, the direction of button arrangement is specified as being the “vertical direction,” and the relative position of buttons in a screen is specified as being “lower right” because the operation button group is adjacent to the right and lower sides of the window outline.

The button layout judgment section 3 checks for layout inconsistency by comparing the direction of button arrangement and the relative position of buttons in a screen between operation button groups involving the same category. In the present example, the operation button group AG1 specified from window A, the operation button group BG2 specified from window B, and the operation button group CG2 specified from window C are first compared as the operation button groups involving the “Decision Making” category. In this instance, the three operation button groups AG1, BG2 and CG2 agree with each other in the relative position of buttons in a screen as their relative button positions are all “lower right.” However, the operation button groups AG1, BG2 and CG2 do not agree with each other in the direction of button arrangement as the buttons in the operation button groups AG1 and BG2 are arranged in the “horizontal direction” whereas the buttons in the operation button group CG2 are arranged in the “vertical direction.” Therefore, the button layout judgment section 3 concludes that the operation buttons belonging to the “Decision Making” category are not consistently laid out.

Next, the button layout judgment section 3 compares the operation button group BG1 which is specified from window B, and the operation button group CG1 which is specified from window C, as the operation button groups involving the “Help” category. In this instance, the two operation button groups BG1 and CG1 agree with each other in the direction of button arrangement and in the relative position of buttons in a screen. Therefore, the button layout judgment section 3 concludes that the operation buttons belonging to the “Help” category are consistently laid out. Eventually, the GUI evaluation system concludes that the operation buttons are not consistently laid out. The button layout judgment section 3 may present the overall judgment result by indicating whether or not any inconsistency is encountered, and present the information indicative of a combination of inconsistent operation button groups and an inconsistent comparison element (arrangement direction or relative position).

As described above, even when all the labels attached to buttons that perform basic operations do not agree with each other, the buttons are grouped in accordance with the information about the labels frequently used for the buttons performing the basic operations and subjected to comparison. Therefore, the layout consistency of the operation buttons can be evaluated comprehensively and unfailingly without overlooking judgment targets or producing varying and conflicting judgment results.

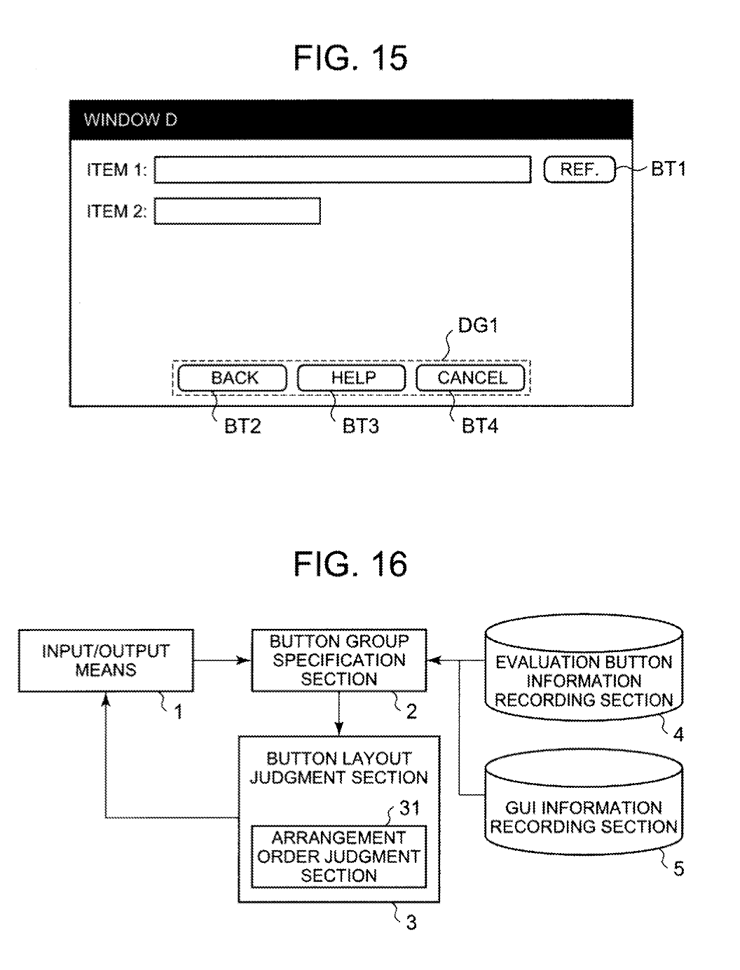

A third concrete example of an operation of the present exemplary embodiment will now be described with reference to a case where window A shown in FIG. 4, window B shown in FIG. 9, and window D shown in FIG. 15 are the evaluation target screens.

The button group specification section 2 performs the same process for window D as for windows A and B, specifies an operation button group from buttons used in window D, and generates operation button group information. In the present example, as for window D, the “Back” button (BT2) and “Cancel” button (BT4) are first extracted as operation buttons belonging to the “Decision Making” category. These two buttons are then used to search for the other buttons within a predetermined range. As a result, one operation button group (DG1) including the “Back” button (BT2), “Help” button (BT3), and “Cancel” button (BT4) is specified as an operation button group involving the “Decision Making” category.

Further, the button group specification section 2 extracts the “Help” button (BT3) as an operation button belonging to the “Help” category. The “Help” button (BT3) has already been searched for in the “Decision Making” category search process to specify the operation button group to which the “Help” button (BT3) belongs. Therefore, the operation button group may be specified as an operation button group that additionally involves the “Help” category. Consequently, as regards window D, one operation button group (DG1) including the “Back” button (BT2), “Help” button (BT3), and “Cancel” button (BT4) is specified as an operation button group that involves the “Decision Making” category and “Help” category. Operation button group information indicative of the result of such specification is then generated.

Next, the button layout judgment section 3 references the operation button group information which is output from the button group specification section 2, and the GUI information, and compares the direction of button arrangement and the relative position of buttons in a screen between operation button groups that are specified from the evaluation target screen and involve the same category.

As regards the operation button group DG1 specified from window D, the button layout judgment section 3 specifies the direction of button arrangement and the relative position of buttons in a screen as described below. The button layout judgment section 3 specifies the direction of button arrangement as being the “horizontal direction” and the relative position of buttons in a screen as being “lower central” because the operation button group is adjacent only to the lower side of the window outline.

The button layout judgment section 3 checks for layout inconsistency by comparing the direction of button arrangement and the relative position of buttons in a screen between operation button groups involving the same category. Here, the operation button group DG1, which is specified from window D includes both an operation button belonging to the “Decision Making” category and an operation button belonging to the “Help” category. Therefore, an operation button group including an operation button belonging to either of the above two categories is regarded as a target of comparison with the operation button group DG1 (as a consistency evaluation target). More specifically, the operation button group AG1 specified from window A, the operation button group BG2 specified from window B, the operation button group DG1 specified from window D are compared as operation button groups involving the “Decision Making” category, and the operation button group BG2 specified from window B and the operation button group DG1 specified from window D are compared as operation button groups involving the “Help” category.

The operation button groups involving the “Decision Making” category agree with each other in the direction of button arrangement because their buttons are arranged in the “horizontal direction.” However, the operation button groups do not entirely agree with each other in the relative position of buttons in a screen as the relative position of buttons in a screen is “lower right” for the operation button group AG1, “lower left,” “lower central,” or “lower right” for the operation button group BG2, and “lower central” for the operation button group DG1. Consequently, it is concluded that the layout of the operation buttons belonging to the “Decision Making” category is not consistent.

Meanwhile, the operation button groups involving the “Help” category agree with each other in the direction of button arrangement because their buttons are arranged in the “horizontal direction.” However, the operation button groups do not agree with each other in the relative position of buttons in a screen as the relative position of buttons in a screen is “upper right” for the operation button group BG1 and “lower central” for the operation button group DG1. Consequently, it is concluded that the layout of the operation buttons belonging to the “Help” category is not consistent. Eventually, the GUI evaluation system concludes that the layout of the operation buttons is not consistent.

As described above, even when there are windows A, B, and D, in which window D is provided with an operation button group including operation buttons that belong to different categories and are arranged within a limited area, and windows A and B are provided with a plurality of operation button groups each of which including only operation buttons that belong to a single category and are dispersedly arranged, the layout consistency of the operation buttons can be evaluated comprehensively and unfailingly without overlooking judgment targets or producing varying and conflicting judgment results.

### Second Embodiment

A second exemplary embodiment of the present invention will now be described. FIG. 15 is a block diagram illustrating an example configuration of the GUI evaluation system according to the second exemplary embodiment of the present invention. The GUI evaluation system shown in FIG. 16 differs from that according to the first exemplary embodiment, which is shown in FIG. 2, in that the button layout judgment section 3 includes an arrangement order judgment section 31.

The arrangement order judgment section 31 checks the labels on operation buttons included in operation button groups involving the same category specified from evaluation target screens. When there are a plurality of operation buttons having the same label, the arrangement order judgment section 31 compares the orders of arrangement of (the positional relationships between) the operation buttons and evaluates the layout consistency by checking whether or not the operation buttons agree with each other in the order of arrangement. In the present example, the order of arrangement is determined by detecting on-screen operation buttons in a manner in which the letter Z is written from the upper legt corner to the lower right corner. The arrangement order judgment section 31 may perform an arrangement order judgment process independently of the other comparison element judgment processes or perform the arrangement order judgment process only when no inconsistency is found in the other comparison element judgment processes. Further, the button layout judgment section 3 may perform the arrangement order judgment process in addition to the other comparison element judgment processes without incorporating the arrangement order judgment section 31. In such a case, when comparing operation button groups including operation buttons belonging to the same category for consistency evaluation purposes, the button layout judgment section 3 may evaluate the layout inconsistency by checking the order of arrangement of operation buttons in a group in addition to the direction of button arrangement in the group and the relative position of on-screen buttons in the group.

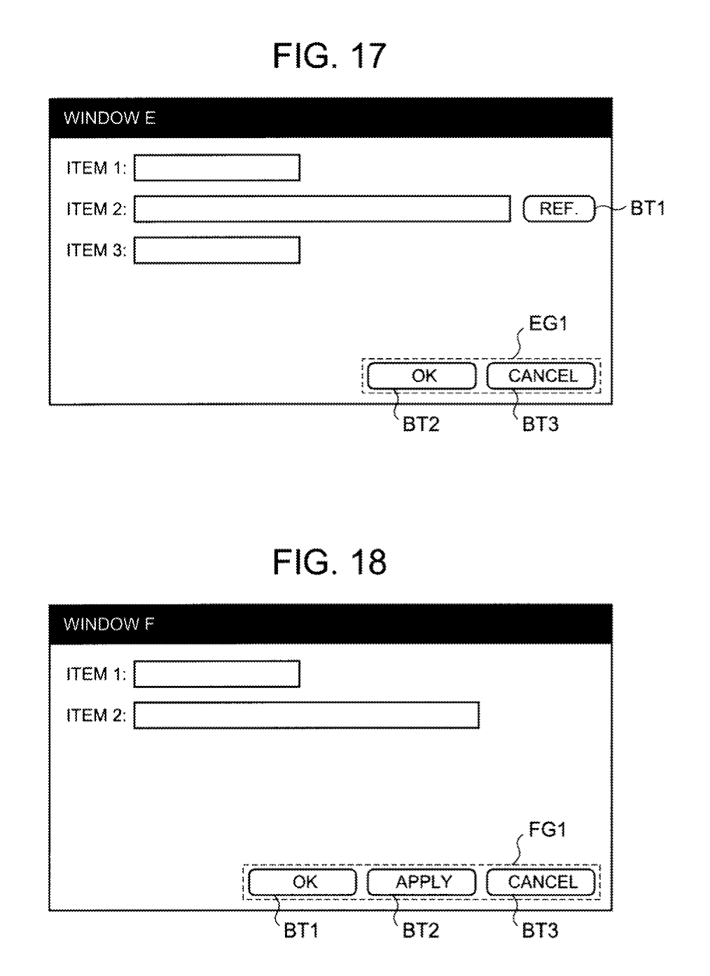

An operation of the present exemplary embodiment will now be described with reference to concrete screen examples. For explanation purposes, it is assumed that window E shown in FIG. 17 and window F shown in FIG. 18 are used as the evaluation target screens. As regards window E, it is assumed that one operation button group EG1 including an “OK” button (BT2) and “Cancel” button (BT3) is specified as an operation button group involving the “Decision Making” category, as shown in FIG. 17. As regards window F, it is assumed that one operation button group FG1 including an “OK” button (BT1), “Apply” button (BT2), and “Cancel” button (BT3) is specified as an operation button group involving the “Decision Making” category, as shown in FIG. 18.

When the operation button group EG1 and the operation button group FG1 are to be compared, the arrangement order judgment section 31 first checks whether or not a plurality of operation buttons having the same label exist in both operation button groups. In the present example, the arrangement order judgment section 31 finds two such buttons labeled “OK” and “Cancel.” The arrangement order judgment section 31 then checks whether or not the operation buttons having the same label agree with each other in the order of arrangement in the operation button groups. In the present example, the “OK” button (BT2) and “Cancel” button (BT3) in the operation button group EG1 are found to be arranged so that the “OK” button is positioned ahead of (to the left of) the “Cancel” button (i.e., the buttons are arranged in order from “OK” to “Cancel”), and the “OK” button (BT1) and “Cancel” button (BT3) in the operation button group FG1 are also found to be arranged so that the “OK” button is positioned ahead of (to the left of) the “Cancel” button (i.e., the buttons are arranged in order from “OK” to “Cancel”). It means that the operation button groups agree with each other in the order of arrangement. Consequently, it is concluded that the buttons are consistently laid out.

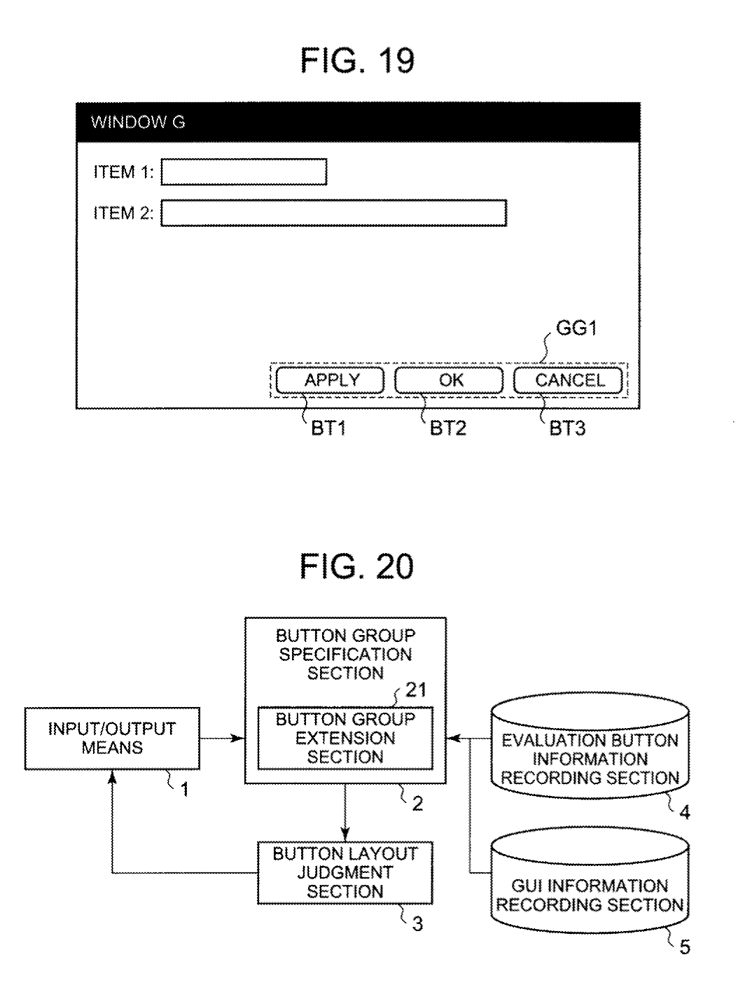

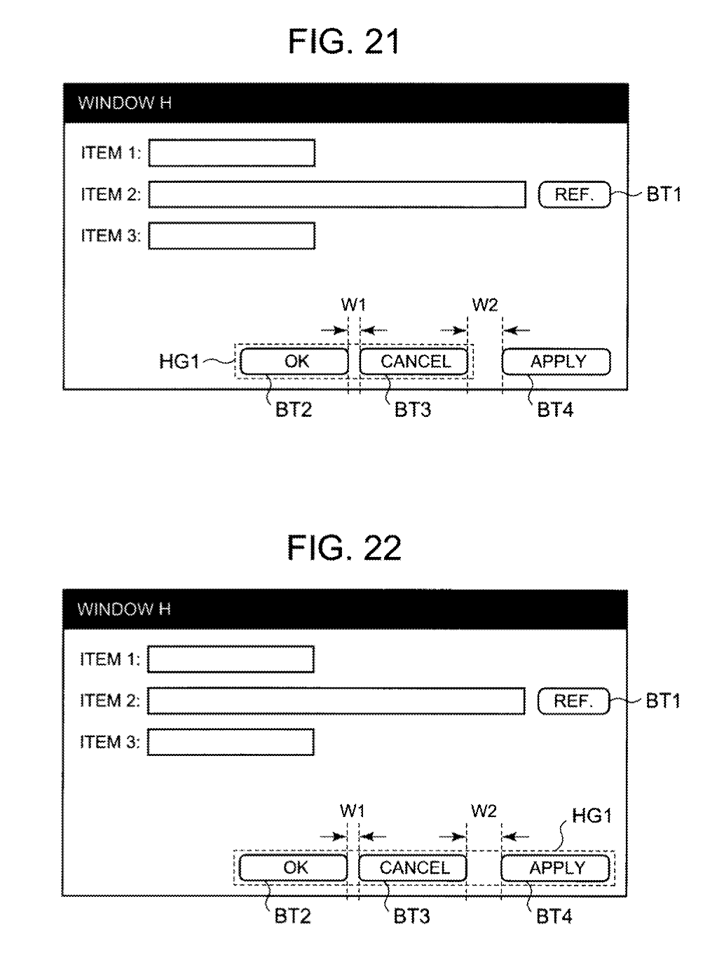

Further, when window G shown in FIG. 19 is included as the evaluation target screen, the following judgment result is obtained. As regards window G, it is assumed that one operation button group GG1 including an “Apply” button (BT1), “OK” button (BT2), and “Cancel” button (BT3) is specified as an operation button group involving the “Decision Making” category, as shown in FIG. 19. When the operation button group GG1 and the above-mentioned operation button group EG1 and operation button group FG1 are compared, the arrangement order judgment section 31 concludes that no inconsistency is found in the order of operation button arrangement between the operation button group GG1 and the operation button group EG1 as the orders of arrangement of the “OK” and “Cancel” buttons, which are the operation buttons having the same label, agree with each other. However, the comparison between the operation button group GG1 and the operation button group FG1 reveals that they do not agree with each other in the order of arrangement of the “OK” button, “Apply” button, and “Cancel” button, which are the operation buttons having the same label. More specifically, the buttons are arranged in order from “Apply” through “OK” to “Cancel” in the operation button group GG1 and in order from “OK” through “Apply” to “Cancel” in the operation button group FG1. As a result, it is concluded that the buttons are not consistently laid out. As inconsistency is found in either of the two operation button group combinations, it is eventually concluded that the layout of the operation buttons in an evaluation target system is not consistent.

As described above, when the order of arrangement of (the positional relationship between) the operation buttons having the same label is compared between the operation button groups including operation buttons belonging to the same category, the layout consistency of the operation buttons can be evaluated in more details.

### Third Embodiment

A third exemplary embodiment of the present invention will now be described. FIG. 20 is a block diagram illustrating an example configuration of the GUI evaluation system according to the third exemplary embodiment of the present invention. The GUI evaluation system shown in FIG. 20 differs from that according to the first exemplary embodiment, which is shown in FIG. 2, in that the button group specification section 2 includes a button group extension section 21.

The button group extension section 21 checks the result of specification of an operation button group including operation buttons belonging to a certain category to judge whether or not any operation button belonging to the same category might be overlooked. If any such operation button might be overlooked, the button group extension section 21 extends the range of operation button group specification and performs grouping again. The button group extension section 21 references, for example, the GUI information stored in the GUI information recording section 5, creates a list of labels on operation buttons that belong to the same category and are included in an evaluation target screen, and compares the created label list against a label list for operation buttons belonging to an operation button group including operation buttons in the same category indicated by operation button group information, which is the result of operation button group specification, to judge whether any operation button might be overlooked. If, for example, any label included in a label list presented by the GUI information is excluded from the label list presented by the operation button group information, the button group extension section 21 concludes that a button having that label might be overlooked, and continues with a search.

The button group extension section 21 may search for a possibly overlooked button label while the direction of button arrangement for the associated operation button group is left unlimited. For example, an “Apply” button (BT4) may be specified as being excluded from an operation button group HG1, which includes the “OK” button (BT2) and “Cancel” button (BT3), because the distance W2 between the “Cancel” button (BT3) and “Apply” button (BT4) is longer than the distance W1 between the “OK” button (BT2) and “Cancel” button (BT3) and outside a predetermined search range.

In the above instance, the button group extension section 21 may reference the GUI information to confirm that the “Apply” button (BT4) which belongs to the “Decision Making” category is not included in the operation button group HG1 which involves the “Decision Making” category, and conclude that the “Apply” button (BT4) might be overlooked. Next, the button group extension section 21 may search for the “Apply” button (BT4) by checking an area ahead of (to the left of) or an area behind (to the right of) the operation button group HG1 because the buttons in the operation button group HG1 are arranged in the “horizontal direction.” If the “Apply” button (BT4) is found during the above search, the button group extension section 21 may specify the “Apply” button (BT4) as a member of the operation button group HG1. FIG. 22 shows an example of the result of operation button group specification by the button group extension section 21. The example shown in FIG. 22 indicates that the operation button group HG1 which includes the “OK” button (BT2), “Cancel” button (BT3), and “Apply” button (BT4), is specified.

In the present exemplary embodiment, the button layout judgment section 3 may evaluate the layout consistency of operation buttons in accordance with an operation button group specified by the button group extension section 21.

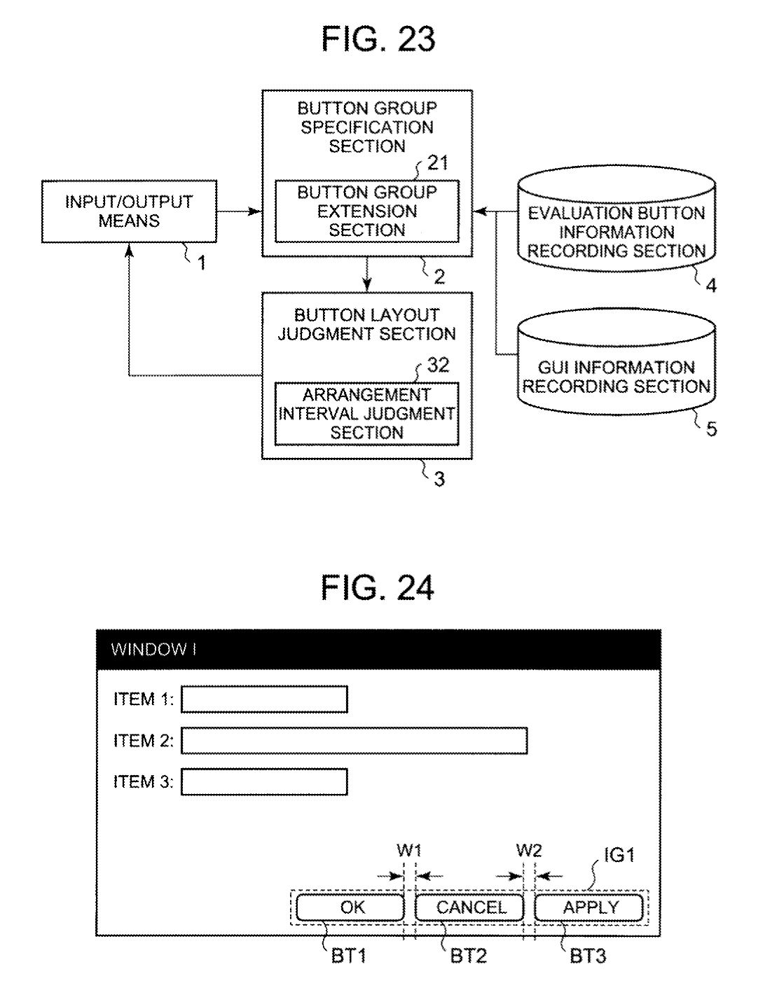

Further, in a situation where the button group specification section 2 includes the button group extension section 21, the button layout judgment section 3 may include an arrangement interval judgment section 32 as shown in FIG. 23. FIG. 23 is a diagram illustrating another example configuration of the GUI evaluation system according to the present exemplary embodiment.

The arrangement interval judgment section 32 checks the labels on operation buttons included in operation button groups involving the same category specified from evaluation target screens. When operation buttons having the same label are found, the arrangement interval judgment section 32 compares the arrangement intervals between such operation buttons and neighboring operation buttons, and evaluates the layout consistency of the operation buttons by judging whether or not the arrangement intervals agree with each other.

An operation of the arrangement interval judgment section 32 will now be described with respect to a case where window H shown in FIG. 22 and window I shown in FIG. 24 are the evaluation target screens. As regards window I, it is assumed that one operation button group IG1 including the “OK” button (BT1), “Cancel” button (BT2), and “Apply” button (BT3) is specified as an operation button group involving the “Decision Making” category, as shown in FIG. 24.

The arrangement interval judgment section 32 compares the operation button group HG1 and the operation button group IG1, which are the operation button groups involving the same category, to check for operation buttons having the same label. Here, the “OK” buttons, “Cancel” buttons, and “Apply” buttons are found. Next, the arrangement interval judgment section 32 compares the arrangement intervals between such operation buttons and buttons neighboring them to judge whether or not they agree with each other. As regards the “OK” buttons, for example, the arrangement interval judgment section 32 may compare the arrangement interval W1 between the “OK” button (BT2) included in the operation button group HG1 and the neighboring “Cancel” button (BT3) against the arrangement interval W1 between the “OK” button (BT1) included in the operation button group IG1 and the neighboring “Cancel” button (BT2). Further, as regards the “Cancel” buttons, the arrangement interval judgment section 32 may compare the arrangement interval W1 between the “Cancel” button (BT3) included in the operation button group HG1 and the neighboring “OK” button (BT2) against the arrangement interval W1 between the “Cancel” button (BT2) included in the operation button group IG1 and the neighboring “OK” button (BT1), and compare the arrangement interval W2 between the “Cancel” button (BT3) included in the operation button group HG1 and the neighboring “Apply” button (BT4) against the arrangement interval W2 between the “Cancel” button (BT2) included in the operation button group IG1 and the neighboring “Apply” button (BT3). The comparison between the arrangement interval W1 for the operation button group HG1 and the arrangement interval W1 for the operation button group IG1 may be omitted because it has already been made by making the comparison concerning the “OK” buttons. Furthermore, as regards the “Apply” buttons, the arrangement interval judgment section 32 may compare the arrangement interval W2 between the “Apply” button (BT4) included in the operation button group HG1 and the neighboring “Cancel” button (BT3) against the arrangement interval W2 between the “Apply” button (BT3) included in the operation button group IG1 and the neighboring “Cancel” button (BT2). The comparison between the arrangement interval W2 for the operation button group HG1 and the arrangement interval W2 for the operation button group IG1 may be omitted because it has already been made by making the comparison concerning the “Cancel” buttons.

In the present example, the arrangement interval W1 for the operation button group HG1 agrees with the arrangement interval W1 for the operation button group IG1; however, the arrangement interval W2 for the operation button group HG1 does not agree with the arrangement interval W2 for the operation button group IG1. Therefore, it is concluded that these operation button groups are not consistent in the operation button arrangement interval. As for an overall judgment, when there is a problem with a combination of operation button groups involving the same category, it may be eventually concluded that the operation buttons in an evaluation target system are not consistently laid out.

As described above, when the arrangement intervals for operation buttons having the same labels are compared between the operation button groups including operation buttons belonging to the same category, the layout consistency of the operation buttons can be evaluated in more details. In the other respects, the present exemplary embodiment is the same as the first exemplary embodiment. Further, the present exemplary embodiment can be used in combination with the second exemplary embodiment. More specifically, the present exemplary embodiment can be used in a configuration in which the arrangement order judgment section 31 evaluates the order of arrangement while the arrangement interval judgment section 32 evaluates the arrangement interval.

### Fourth Embodiment

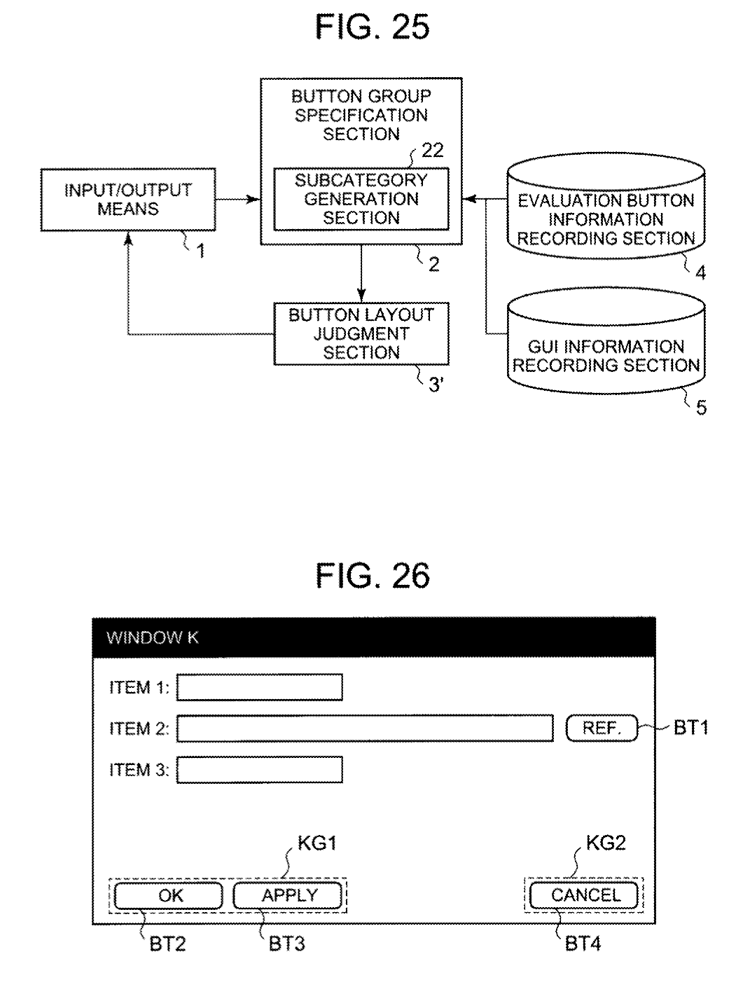

A fourth exemplary embodiment of the present invention will now be described. FIG. 25 is a block diagram illustrating an example configuration of the GUI evaluation system according to the fourth exemplary embodiment of the present invention. The GUI evaluation system shown in FIG. 25 differs from that according to the first exemplary embodiment which is shown in FIG. 2, not only in that the button group specification section 2 includes a subcategory generation section 22, but also in that the button layout judgment section 3 is replaced by a button layout judgment section 3′.

When a plurality of operation button groups involving the same category are disposed in the same screen, the subcategory generation section 22 determines subcategories for the operation button groups in accordance with the labels on the operation buttons included in the operation button groups.

FIGS. 26 to 28 show examples of an evaluation target screen. In window K shown in FIG. 26, for example, the “OK” button (BT2), “Apply” button (BT3), and “Cancel” button (BT4) are disposed as operation buttons belonging to the “Decision Making” category. It should be noted, however, that the “Cancel” button (BT4) is positioned apart from the “OK” button (BT2) and “Apply” button (BT3). In window K, therefore, a total of two operation button groups, namely, an operation button group KG1 including the “OK” button (BT2) and “Apply” button (BT3) and an operation button group KG2 including the “Cancel” button (BT4) may be specified as operation button groups involving the “Decision Making” category, as shown in FIG. 26.

In the above instance, the subcategory generation section 22 generates a list of labels on the buttons included in each operation button group involving the same category and determines subcategories for the categories (a plurality of categories existing in a single screen) involved in an operation button group in accordance with labels not used on the buttons included in the other operation button groups. In the present example, the labels (“OK” and “Apply”) on the buttons included in the operation button group KG1 do not agree with the label on the button included in the other operation button group KG2 involving the same category. Therefore, one subcategory may be generated as a subcategory including the “OK” and “Apply” labels. In the present example, it is assumed that an “OK” subcategory (SUB1) is generated. It is also assumed that this subcategory includes the “OK” and “Apply” labels. The subcategory generation section 22 may generate information indicative of the relationship between an identifier of the generated subcategory and the information about the included labels. The operation button group KG1 is then recognized as an operation button group that involves a “Decision Making—OK” category.

Similarly, the label (“Cancel”) on the button included in the operation button group KG2 does not agree with either of the labels on the buttons included in the other operation button group KG1 involving the same category. Therefore, the subcategory generation section 22 may determine one subcategory for the operation button group KG2 as a subcategory including the “Cancel” label. In the present example, it is assumed that a “Cancel” subcategory (SUB2) is generated. It is also assumed that this subcategory includes the “Cancel” label. The operation button group KG2 is then recognized as an operation button group that involves a “decision making—Cancel” category.

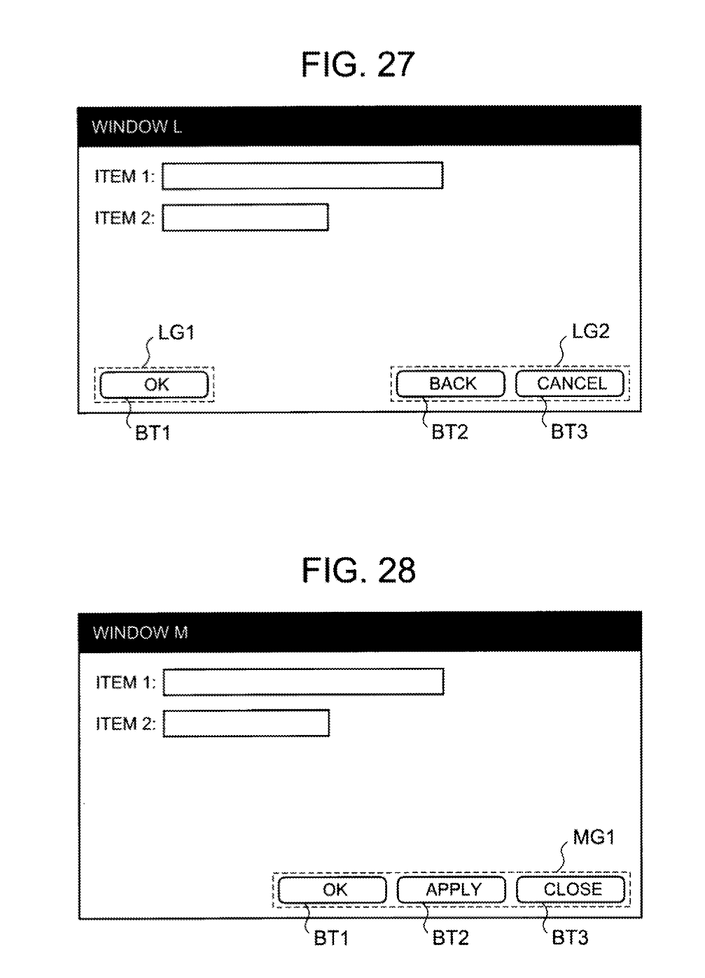

In window L, which is shown in FIG. 27, a total of two operation button groups, namely, an operation button group LG1 including the “OK” button (BT1) and an operation button group KG2 including the “Back” button (BT2) and “Cancel” button (BT4) may be specified as operation button groups involving the “Decision Making” category. In this instance, as for the operation button group LG1, the subcategory generation section 22 uses the previously generated “OK” subcategory (SUB1) because the “OK” label on the button included in the operation button group LG1 is included in the previously generated “OK” subcategory (SUB1). In other words, the operation button group LG1 is regarded as an operation button group involving the “Decision Making—OK” category. As for the operation button group LG2, which includes the buttons labeled “Back” and “Cancel,” the subcategory generation section 22 uses the previously generated “Cancel” subcategory (SUB2) because the “Cancel” label on a button in the operation button group LG2 is included in the previously generated “Cancel” subcategory (SUB2). In addition, the subcategory generation section 22 causes the label information about the “Cancel” subcategory (SUB2) to include the “Back” label, which is not included in the label information about the “Cancel” subcategory (SUB2) assigned to a button included in the operation button group LG2. As a result, the “Cancel” subcategory (SUB2) includes “Cancel” and “Back” as the label information.

When there are operation button groups involving subcategories, the button layout judgment section 3′ compares the operation button groups involving the same subcategories. However, if no, subcategory is defined for an operation button group involving a category (higher-level category) for which a subcategory is generated, the button layout judgment section 3′ compares the operation button group against another operation button group having a subcategory that includes the same label as a label on a button included in the aforementioned operation button group.

As regards window M, which is shown in FIG. 28, one operation button group MG1 including the “OK” button (BT1), “Apply” button (BT2), and “Close” button (BT3) may be specified as an operation button group involving the “Decision Making” category. When windows K, L, and M, which are shown in FIGS. 26, 27, and 28, respectively, are the evaluation target screens, the button layout judgment section 3′ performs a judgment process by comparing the following operation button groups because the operation button group MG1 in window M involves the “Decision Making” category, which is a higher-level category including no subcategory, and includes the “OK” button (BT1) or the “Apply” button (BT2). More specifically, the button layout judgment section 3′ performs a judgment process, as regards the “Decision Making—OK” category, by comparing the operation button group MG1 in window M, the operation button group KG1 in window K, and the operation button group LG1 in window L. Further, as regards the “Decision Making—Cancel” category, the operation button group KG2 in window K and the operation button group LG2 in window L are compared to perform a judgment process. In this judgment process, the operation button group MG1 in window M is excluded from comparison. The reason is that neither the “Cancel” label nor the “Back” label is included in the operation button group MG1. The button layout judgment section 3′ may perform the judgment process in the same manner as the button layout judgment section 3, which is used in the first to third exemplary embodiments.

As described above, even when a plurality of operation button groups involving the same category exist in the same screen, it is possible to evaluate the consistency of operation buttons in each of the operation button groups.

The evaluation button information recording section, GUI information recording section, button group specification section, and button layout judgment section described in connection with the foregoing exemplary embodiments may be implemented as separate units.

The foregoing exemplary embodiments represent characteristic configurations of the GUI evaluation system as described under (1) to (8) below.

(1) The GUI evaluation system includes an evaluation button information recording section (which is implemented, for instance, by the evaluation button information storage means 101 and the evaluation button information recording section 4), a GUI information recording section (which is implemented, for instance, by the GUI information storage means 102 and the GUI information recording section 5), a button group specification section (which is implemented, for instance, by the button group specification means 103 and the button group specification section 2), and a button layout evaluation section (which is implemented, for instance, by the button layout evaluation means 104 and the button layout judgment section 3). The evaluation button information recording section stores evaluation button information which indicates each category corresponding label information being text used as a label of the operation button that is disposed in an evaluation target screen and used for a basic operation, each category indicated by a type of operation performed by the operation button. The GUI information recording section stores GUI information including a size of the evaluation target screen and each button included in the screen, and GUI information including at least the label information and coordinate data indicative of a position of each button in the screen. The button group specification section specifies an operation button group, based on inter-button distance referenced to the operation button, on buttons disposed in the evaluation target screen at each evaluation target screen, in accordance with the GUI information stored in the GUI information recording section and the evaluation button information stored in the evaluation button information recording section. The button layout evaluation section evaluates the layout consistency of operation buttons between a plurality of evaluation target screens by comparing operation button groups each including an operation button belonging to a same category as the other operation button group, which are each specified from each of the evaluation target screens.

(2) The button group specification section in the GUI evaluation system may extract operation buttons disposed in an evaluation target screen in accordance with the evaluation button information stored in the evaluation button information recording section, use one of the extracted operation buttons as an initial base point, repeatedly search for a neighboring operation button within a predetermined rectangular range from the operation button used as the initial base point until no more operation button is found with the newly found operation button used as the next base point, and specify the operation button used as the initial base point and the later-found operation buttons as the members of the same operation button group.

(3) The button layout evaluation section in the GUI evaluation system may compare comparison elements of operation buttons between operation button groups each including operation buttons belonging to an identical category that is the same category as the other operation button group, the comparison elements being a direction of operation button arrangement and a relative position of operation buttons in a screen. When the operation buttons do not agree with each other in any one of the comparison elements in any combination, the button layout evaluation section may conclude that the operation buttons are inconsistent in layout.

(4) The button layout evaluation section in the GUI evaluation system may compare an order of arrangement of operation buttons having labels between the same labels between operation button groups each including operation buttons belonging to an identical category that is the same category as the other operation button group. When any combination exhibits a conflicting order of arrangement, the button layout evaluation section may conclude that the operation buttons are inconsistent in the order of arrangement.

(5) In a case where a certain operation button group specified from an evaluation target screen does not include all operation buttons that belong to the category to which the operation buttons specified as the members of the operation button group belong and are used in the evaluation target screen, the button group specification section in the GUI evaluation system may search a search range within the evaluation target screen in the direction of button arrangement of the operation button group in order to find the excluded operation buttons. When any such excluded operation button is found within the search range, the button group specification section may newly specify the found operation button as a member of the operation button group.

(6) The button layout evaluation section in the GUI evaluation system may compare an interval of arrangement of operation buttons having labels between the same labels between operation button groups each including operation buttons belonging to an identical category that is the same category as the other operation button group, the interval of arrangement being a distance between the operation buttons. When any combination exhibits a conflicting interval of arrangement, the button layout evaluation section may conclude that the operation buttons are inconsistent in the interval of arrangement.

(7) When a plurality, of operation button groups each including operation buttons belonging to an identical category that is the same category as the other operation button group are specified from a certain evaluation target screen, the button group specification section in the GUI evaluation system may assign a subcategory to the operation button groups and define the labels on the operation buttons belonging to the subcategory in accordance with the labels on the operation buttons belonging to the same category included in the operation button groups. When operation button groups each including operation buttons belonging to an identical category that is the same category as the other operation button group are specified from a certain evaluation target screen, the button layout evaluation section may compare, as regards the same category, operation button groups that agree with each other in the assigned category, against an operation button group that has no assigned subcategory and includes operation buttons having labels belonging to the subcategory.

(8) The GUI evaluation system includes evaluation button information storage means (which is implemented, for instance, by the evaluation button information storage means 101 and the evaluation button information recording section 4), GUI information storage means (which is implemented, for instance, by the GUI information storage means 102 and the GUI information recording section 5), button group specification means (which is implemented, for instance, by the button group specification means 103 and the button group specification section 2), and button layout evaluation means (which is implemented, for instance, by the button layout evaluation means 104 and the button layout judgment section 3). The evaluation button information storage means stores evaluation button information which is obtained by classifying label information according to a category indicated by a type of operation performed by an operation button that is disposed in an evaluation target screen and used for a basic operation, the label information indicating text used as a label on the operation button. The GUI information storage means stores GUI information concerning a size of the evaluation target screen and each button included in the screen, the GUI information including at least the label information and coordinate data indicative of the position of each button in the screen. The button group specification means specifies an operation button group which is formed by buttons disposed in the evaluation target screen based on an inter-button distance that is referenced to an operation button, in relation to each evaluation target screen and in accordance with the GUI information stored in the GUI information storage means and the evaluation button information stored in the evaluation button information storage means. The button layout evaluation means evaluates the layout consistency of operation buttons between a plurality of evaluation target screens by comparing operation button groups each including an operation button belonging to a same category as the other operation button group, which are each specified from each of the evaluation target screens.

While the present invention has been described in terms of preferred exemplary embodiments and examples, it will be understood by those skilled in the art that the invention is not limited to those preferred exemplary embodiments and examples, and that modifications and variations can be made without departing from the spirit and scope of the invention.

This application is based upon and claims the benefit of priority from Japanese patent application No. 2008-251809, filed on Sep. 29, 2008, the disclosure of which is incorporated herein in its entirety by reference.

### INDUSTRIAL APPLICABILITY

The present invention is preferably applicable to the evaluation of the usability of a system.

### REFERENCE SIGNS LIST

101 Evaluation button information storage means
102 GUI information storage means
103 Button group specification means
104 Button layout evaluation means
1 Input/output means
2 Button group specification section
21 Button group extension section
22 Subcategory generation section
3, 3′ Button layout judgment section
31 Arrangement order judgment section
32 Arrangement interval judgment section
4 Evaluation button information recording section
5 GUI information recording section

1-21. (canceled)

22. A GUI evaluation system comprising:
an evaluation button information storage section for storing evaluation button information which indicates each category corresponding label information being text used as a label of the operation button that is disposed in an evaluation target screen and used for a basic operation, each category indicated by a type of operation performed by the operation button;
a GUI information storage section for storing GUI information including a size of the evaluation target screen and each button included in the screen, and GUI information including at least the label information and coordinate data indicative of a position of each button in the screen;
a button group specification section for specifying an operation button group, based on inter-button distance referenced to the operation button, on buttons disposed in the evaluation target screen at each evaluation target screen, in accordance with the GUI information stored in the GUI information storage section and the evaluation button information stored in the evaluation button information storage section; and
a button layout evaluation section for evaluating a layout consistency of operation buttons between a plurality of evaluation target screens by comparing operation button groups each including an operation button belonging to a same category as the other operation button group, each of the operation button groups being specified from each of the evaluation target screens.

23. The GUI evaluation system according to claim 22, wherein the button group specification section extracts operation buttons disposed in an evaluation target screen in accordance with the evaluation button information stored in the evaluation button information storage section, uses one of the extracted operation buttons as an initial base point, repeatedly searches for a neighboring operation button within a predetermined rectangular range from the operation button used as the initial base point until no more operation button is found with a newly found operation button used as a next base point, and specifies the operation button used as the initial base point and the later-found operation buttons as the members of the same operation button group.

24. The GUI evaluation system according to claim 22, wherein the button layout evaluation section compares comparison elements of operation buttons between operation button groups each including operation buttons belonging to an identical category that is the same category as the other operation button group, the comparison elements being a direction of operation button arrangement and a relative position of operation buttons in a screen, and when the operation buttons do not agree with each other in any one of the comparison elements in any combination, concludes that the operation buttons are inconsistent in layout.

25. The GUI evaluation system according to claim 22, wherein the button layout evaluation section compares an order of arrangement of operation buttons having labels between the same labels between operation button groups each including operation buttons belonging to an identical category that is the same category as the other operation button group, and when any combination exhibits a conflicting order of arrangement, concludes that the operation buttons are inconsistent in the order of arrangement.

26. The GUI evaluation system according to claim 22, wherein,
in a case where a certain operation button group specified from an evaluation target screen does not include all operation buttons that belong to the category to which the operation buttons specified as the member of the operation button group belong and that are used in the evaluation target screen, the button group specification section searches a search range within the evaluation target screen in the direction of button arrangement of the operation button group in order to find the excluded operation buttons, and when any such excluded operation button is found within the search range, newly specifies the found operation button as a member of the operation button group.

27. The GUI evaluation system according to claim 26, wherein the button layout evaluation section compares an interval of arrangement of operation buttons having labels between the same labels between operation button groups each including operation buttons belonging to an identical category that is the same category as the other operation button group, the interval of arrangement being a distance between the operation buttons, and when any combination exhibits a conflicting interval of arrangement, concludes that the operation buttons are inconsistent in the interval of arrangement.

28. The GUI evaluation system according to claim 22,
wherein, when a plurality of operation button groups each including operation buttons belonging to an identical category that is the same category as the other operation button group are specified from a certain evaluation target screen, the button group specification section assigns a subcategory to the operation button groups and defines the labels on the operation buttons belonging to the subcategory in accordance with the labels on the operation buttons belonging to the category included in the operation button groups; and
wherein, when operation button groups each including operation buttons belonging to the identical category that is the same category as the other operation button group are specified from a certain evaluation target screen, the button layout evaluation section compares, as regards the category, operation button groups that agree with each other in the assigned category, against an operation button group that has no assigned subcategory and includes operation buttons having labels belonging to the subcategory.

29. A GUI evaluation method comprising:
specifying an operation button group, based on inter-button distance referenced to an operation button, on buttons disposed in an evaluation target screen at each evaluation target screen, in accordance with evaluation button information and GUI information, the evaluation button information which indicates each category corresponding label information being text used as a label of the operation button that is disposed in an evaluation target screen and used for a basic operation, each category indicated by a type of operation performed by the operation button, and the GUI information including a size of the evaluation target screen and each button included in the screen, and the GUI information further including at least the label information and coordinate data indicative of a position of each button in the screen; and
evaluating the layout consistency of operation buttons between a plurality of evaluation target screens by comparing operation button groups each including operation buttons belonging to an identical category that is the same category as the other operation button group, each of the operation button groups being specified from each of the evaluation target screens.

30. The GUI evaluation method according to claim 29, further comprising:
extracting operation buttons disposed in an evaluation target screen in accordance with the evaluation button information;
using one of the extracted operation buttons as an initial base point;
repeatedly searching for a neighboring operation button within a predetermined rectangular range from the operation button used as the initial base point until no more operation button is found with a newly found operation button used as a next base point; and
specifying the operation button used as the initial base point and the later-found operation buttons as the members of the same operation button group.

31. The GUI evaluation method according to claim 29, further comprising:
comparing comparison elements of operation buttons between operation button groups each including operation buttons belonging to an identical category that is the same category as the other operation button group, the comparison elements being a direction of operation button arrangement and a relative position of operation buttons in a screen, and when the operation buttons do not agree with each other in any one of the comparison elements in any combination, concluding that the operation buttons are inconsistent in layout.

32. The GUI evaluation method according to claim 29, further comprising:
comparing an order of arrangement of operation buttons having labels between the same labels between operation button groups each including operation buttons belonging to an identical category that is the same category as the other operation group, and when any combination exhibits a conflicting order of arrangement, concluding that the operation buttons are inconsistent in the order of arrangement.

33. The GUI evaluation method according to claim 29, further comprising:
in a case where a certain operation button group specified from an evaluation target screen does not include all operation buttons that belong to the category to which the operation buttons specified as the members of the operation button group belong and that are used in the evaluation target screen, searching a search range within the evaluation target screen in the direction of button arrangement of the operation button group in order to find the excluded operation buttons, and when any such excluded operation button is found within the search range, newly specifying the found operation button as a member of the operation button group.

34. The GUI evaluation method according to claim 33, further comprising:
comparing an interval of arrangement of operation buttons having labels between the same labels between operation button groups each including operation buttons belonging to an identical category that is the same category as the other operation button group, the interval of arrangement being a distance between the operation buttons, and when any combination exhibits a conflicting interval of arrangement, concluding that the operation buttons are inconsistent in the interval of arrangement.

35. The GUI evaluation method according to claim 29, further comprising:
when a plurality of operation button groups each including operation buttons belonging to an identical category that is the same category as the other operation button group are specified from a certain evaluation target screen, assigning a subcategory to the operation button groups and defining the labels on the operation buttons belonging to the subcategory in accordance with the labels on the operation buttons belonging to the category included in the operation button groups; and
when operation button groups each including operation buttons belonging to the identical category that is the same category as the other operation button group are specified from a certain evaluation target screen, comparing, as regards the same category, operation button groups that agree with each other in the assigned category, against an operation button group that has no assigned subcategory and includes operation buttons having labels belonging to the subcategory.

36. A GUI evaluation program making a computer perform:
a button group specification process for specifying an operation button group, based on inter-button distance referenced to an operation button, on buttons disposed in an evaluation target screen at each evaluation target screen, in accordance with evaluation button information and GUI information, the evaluation button information which indicates each category corresponding label information being text used as a label of the operation button that is disposed in an evaluation target screen and used for a basic operation, each category indicated by a type of operation performed by the operation button, and the GUI information including a size of the evaluation target screen and each button included in the screen, and the GUI information further including at least the label information and coordinate data indicative of a position of each button in the screen; and
a button layout evaluation process for evaluating the layout consistency of operation buttons between a plurality of evaluation target screens by comparing operation button groups each including operation buttons belonging to an identical category that is the same category as the other operation button group, each of the operation button groups being specified from each of the evaluation target screens.

37. The GUI evaluation program according to claim 36, making a computer perform in the button group specification process:
extracting operation buttons disposed in an evaluation target screen in accordance with the evaluation button information;
using one of the extracted operation buttons as an initial base point;
repeatedly searching for a neighboring operation button within a predetermined rectangular range from the operation button used as the initial base point until no more operation button is found with a newly found operation button used as a next base point; and
specifying the operation button used as the initial base point and the later-found operation buttons as the members of the same operation button group.

38. The GUI evaluation program according to claim 36, making a computer perform in the button layout evaluation process:
comparing comparison elements of operation buttons' between operation button groups each including operation buttons belonging to an identical category that is the same category as the other operation button group, the comparison elements being a direction of operation button arrangement and a relative position of operation buttons in a screen, and when the operation buttons do not agree with each other in any one of the comparison elements in any combination, concluding that the operation buttons are inconsistent in layout.

39. The GUI evaluation program according to claim 36, making a computer perform in the button layout evaluation process:
comparing an order of arrangement of operation buttons having labels between the same labels between operation button groups each including operation buttons belonging to an identical category that is the same category as the other operation group, and when any combination exhibits a conflicting order of arrangement, concluding that the operation buttons are inconsistent in the order of arrangement.

40. The GUI evaluation program according to claim 36, making a computer perform in the button group specification process:
in a case where a certain operation button group specified from an evaluation target screen does not include all operation buttons that belong to the category to which the operation buttons specified as the members of the operation button group belong and that are used in the evaluation target screen, searching a search range within the evaluation target screen in the direction of button arrangement of the operation button group in order to find the excluded operation buttons, and when any such excluded operation button is found within the search range, newly specifying the found operation button as a member of the operation button group.

41. The GUI evaluation program according to claim 40, making a computer perform in the button layout evaluation process:
comparing an interval of arrangement of operation buttons having labels between the same labels between operation button groups each including operation buttons belonging to an identical category that is the same category as the other operation button group, the interval of arrangement being a distance between the operation buttons, and when any combination exhibits a conflicting interval of arrangement, concluding that the operation buttons are inconsistent in the interval of arrangement.

42. The GUI evaluation program according to claim 36, making a computer perform in the button group specification process:
when a plurality of operation button groups each including operation buttons belonging to an identical category that is the same category as the other operation button group are specified from a certain evaluation target screen, assigning a subcategory to the operation button groups and defining the labels on the operation buttons belonging to the subcategory in accordance with the labels on the operation buttons belonging to the same category included in the operation button groups; and wherein the button layout evaluation process includes the step of, when operation button groups including operation buttons belonging to the same category are specified from a certain evaluation target screen, comparing, as regards the same category, operation button groups that agree with each other in the assigned category, against an operation button group that has no assigned subcategory and includes operation buttons having labels belonging to the subcategory.
